(19) United States
(12) Patent Application Publication
(10) Pub. No.: US 2025/0381752 A1
(43) Pub. Date: Dec. 18, 2025

(54) CORRUGATING AND DIE-CUTTING SYSTEM AND METHOD FOR OPERATING THE SAME

(71) Applicants: Dmitry MAMLIN, Ashqelon (IL); Liad SEGEV, Ramat HaSharon (IL)

(72) Inventors: Dmitry MAMLIN, Ashqelon (IL); Liad SEGEV, Ramat HaSharon (IL)

(21) Appl. No.: 18/878,742

(22) PCT Filed: Jun. 21, 2023
(86) PCT No.: PCT/IL2023/050640

§ 371 Date: Dec. 24, 2024

(30) Foreign Application Priority Data
Jun. 26, 2022 (IL) 294281

(51) Int. Cl. B31D 3/00; B31F 1/24

(52) U.S. Cl. CPC B31D 3/007; B31F 1/24; B31D 2201/00

(57) ABSTRACT

A unified corrugator and die-cutting system is disclosed. The system comprises: (a) a corrugator configured to produce an elongated and multi-layer moving strip of corrugated board; (b) and a die-cutting machine configured to receive said strip of corrugated cardboard and repeatedly cut it to a plurality of shaped boards.

### FIELD OF THE INVENTION

The invention generally relates to the paper industry field, particularly corrugated cardboard production, such as corrugated cardboard used for packaging. More specifically, the invention relates to a unified system combining corrugating and die-cutting within a single system where the die-cutting machinery receives a strip of multi-layered cardboard from a modified corrugator.

### BACKGROUND OF THE INVENTION

The container-board production (also referred to herein as corrugated board) is the highest of all kinds of paper globally. More than 100 million tons of corrugated boards are produced annually.

Corrugated boards are manufactured by large high-precision machinery lines called corrugators, usually running at about 500 feet per minute (150 m/min), typically 50-400 m/min. The corrugator includes a set of machines that combine two, three, five, or seven sheets of paper in a continuous process to temporarily form (within the corrugator) a strip of a unified board, which is then cut into separate (typically square or rectangular) boards. The term “strip” refers to a substantially flat and “elongated” object. “Elongated” is meant to strip even as long as the paper wound on the corrugator's feeding reel/s.

In its most conventional, 3-layer form, the corrugator applies at least five key stages: (a) corrugating a liner to form a flute (the flute is the corrugated, middle layer of the final product); (b) gluing the flute to a first layer of flat paper to form a joined liner; and (c) gluing an additional flat liner of paper to the other side of the flute within the previously joined liner, thereby to form a unified and rigid strip of corrugated cardboard; (d) heating the strip to dry the glue; and (e) cutting the strip to separate rectangular boards using a set of longitudinal and transverse blades.

In the more complex forms of five or seven layers, steps (b) and (c) of the above stages are repeated to receive the final distinct rectangular boards having five or seven layers.

The primary material in the corrugating process is paper—different grades are sometimes used for each layer making up the final product. Due to supply chain and scale considerations, the paper is typically produced in a separate plant (paper mill) and supplied to the corrugator as paper reels. Several supply reels, one for each layer, are positioned at the inlets of the corrugator. Corrugators have become very complex and expensive machines in a try to increase throughput and reliability.

As mentioned, all corrugators traditionally output pluralities of distinct corrugated boards. The distinct boards are then separately conveyed to a die-cutting machine to create the final product, namely, corrugated cardboards specially configured in shape and dimensions to a specific packing product (or for another use). Die-cutting machines are sometimes located within the same manufacturing facility (as the corrugator) or at a separate facility (operated by the same or another entity relative to the corrugator's operator).

Die-cutting machines typically utilize various forms of templates, such as flatbed or rotary press types. In any case, die-cutting machines for processing corrugated boards are designed to (a) receive distinct rectangular (or another profile) boards; and (b) cut, shape, and/or warp each board to form a final product especially designed, in shape and dimensions, for a specific purpose. Once receiving a distinct corrugated board at the input, the die-cutting machine can be configured to produce, for example, a pizza box, a box for packing an electric appliance, a box for containing fruits, or any other packing (or other) products. In any case, all the die-cutting machines for processing and shaping corrugated boards receive at their inlet distinct boards and are configured to output boards that are shaped and cut to size and optionally adapted for easy folding to a 3D box by the end user.

Each corrugator and die-cutting machine require separate operators, typically 5 to 10 workers at any given time for each such machine. Moreover, when these machines are located at different facilities, additional vehicles and workers are required to carry out the transportation. Moreover, the die-cut machine is forced to receive a board with dimensions as produced by the corrugator, resulting in a significant loss of material in the die-cut machine's final product.

It is an object of the present invention to provide a system that simplifies the manufacturing of products made from corrugated cardboard.

Another object of the invention is to provide a system that significantly saves paper material in manufacturing products made from corrugated cardboard.

Another object of the invention is to provide a system that reduces the workforce involved in producing products made from corrugated cardboard.

It is still another object of the invention to provide a system that significantly increases the throughput of corrugators and die-cutting machines that work serially.

Other objects and advantages become apparent as the description proceeds.

### SUMMARY OF THE INVENTION

The invention relates to a unified corrugator and die-cutting system, comprising: (a) a corrugator configured to produce an elongated and multi-layer moving strip of corrugated board; (b) and a die-cutting machine configured to receive said strip of corrugated cardboard and repeatedly cut it to a plurality of shaped boards.

In an embodiment of the invention, transverse and longitudinal blades are eliminated at the corrugator.

In an embodiment of the invention, the elongated multi-layer strip includes 2, 3, 5, or 7 layers.

In an embodiment of the invention, the strip includes a print, and wherein the print is selected from preprinted, printed within the corrugator, or printed within or after the die-cutting machine.

In an embodiment of the invention, the corrugator includes a built-in printer selected from a flexo-type printer, an offset printer, a rotative printer, or a digital printer.

In an embodiment of the invention, a separate glue-drying unit of the corrugator is positioned above the corrugator's main body.

The system of claim 1, further comprising synchronization between the strip's speed of movement at the corrugator's outlet and the die-cutting machine's speed of operation.

In an embodiment of the invention, the synchronization is performed utilizing a synchronization unit external to the corrugator and the die-cutting machine at an area between them.

In an embodiment of the invention, the system comprising two alternatively operating die-cutting machines.

In an embodiment of the invention, the synchronization unit comprising: (a) said strip forming an above-ground curve of a predefined height h; (b) a laser unit continuously measuring said height h and feeding said height to a synchronization entity; and (c) said synchronization entity configured to receive said height h and adjust one or more of the corrugator or die-cutting machines' speed of operation to keep the height h constant.

In an embodiment of the invention, the synchronization is obtained by a die-cutting machine, which comprises: (a) higher and lower bases, wherein the higher base comprises a flatbed template facing down, and the lower base comprises a flat surface facing template; up towards said (b) mechanism configured to apply a revolving circular or ellipsoidal movement to each said upper and lower bases, such that upon engagement, said two bases are horizontal relative to a corrugated strip passing between them; and (c) a synchronization unit configured to syncronize between a horizontal movement vector of the two bases and between a speed of the strip moving between them at each engagement time.

In an embodiment of the invention, the mechanism comprises (a) driving elements at each said upper and lower bases; (b) axels attached to said driving elements; and (c) a motor configured to apply opposite-direction rotation to the axels driving the upper base relative to the axels driving the lower base.

In an embodiment of the invention, the system further comprising a feeding assistance device at the entry of the die-cutting machine.

In an embodiment of the invention, the die-cutting machine is selected from rotatable or flatbed type die-cutting machines.

In an embodiment of the invention, the system further comprises a static or dynamic conveyor between the corrugator and die-cutting machine, which is configured to assist in the movement of the strip.

The invention also relates to a method for producing shaped corrugated boards, comprising: (a) providing a corrugator that is configured to produce an elongated multi-layer corrugated strip; and providing a die-cutting machine configured to continuously receive said multi-layer corrugated strip and cut the strip to separate shaped boards.

In an embodiment of the invention, the method further comprises printing the strip before the corrugator, within the corrugator, or within the die-cutting machine, or printing the separate shaped boards outside the die-cutting machine.

In an embodiment of the invention, the method further comprises synchronizing between the corrugator's and die-cutting machine's speeds of operation speeds.

In an embodiment of the invention, the method further comprising: (a) providing a second die-cutting machine, while at any given time at most one of the die-cutting machines is active and the other is inactive; (b) when an alteration to a new job is desired, mounting a new template within the inactive die cutting machine, and fine-tuning the inactive die-cutting machine; and (c) activating operation with the newly tuned die-cutting machine.

### BRIEF DESCRIPTION OF THE DRAWINGS

In the drawings:

FIG. 1 illustrates a general structure of a prior art corrugated board;

FIG. 2 illustrates a general structure of a prior art corrugator;

FIG. 3 illustrates a general structure of a corrugator modified according to an embodiment of the present invention;

FIG. 4a illustrates a general structure of a unified corrugator and die-cutting system according to an embodiment of the invention;

FIG. 4b illustrates a system similar to the system of FIG. 4a, however, with two alternatively working die-cutting machines;

FIG. 5 illustrates a general structure of a unified corrugator and die-cutting system according to an embodiment of the invention; and

FIG. 6 illustrates a general structure of of a corrugator modified according to an embodiment of the present invention, that includes a built-in printer;

FIG. 7a illustrates a general structure of a unified corrugator and die-cutting system according to an additional embodiment of the invention;

FIG. 7b illustrates a structure of a synchronization mechanism within the die-cutting machine;

FIGS. 7c-7f show various states of the synchronizing mechanism within the die-cutting machine; and

FIG. 7g illustrates the revolving movements of the two bases of the synchronization mechanism.

### DETAILED DESCRIPTION OF PREFERRED EMBODIMENTS

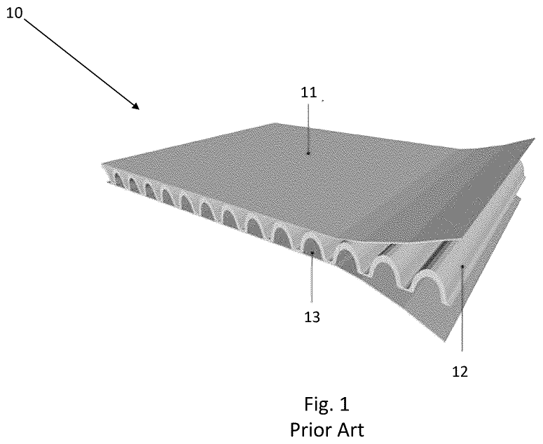

FIG. 1 illustrates a general structure of a 3-layer corrugated board 10. The board includes a first outer layer 11, a middle fluting layer 12, and a second outer layer 13. All the layers are typically made of paper, while the middle layer is sometimes made of another type of paper than the outer layers. The three layers are adhesively attached to one another by glue. 2-layer, 5-layer, and 7-layer corrugated boards also commonly exist. The system and method of the invention apply to all four types of corrugated boards (2, 3, 5, or 7 layers).

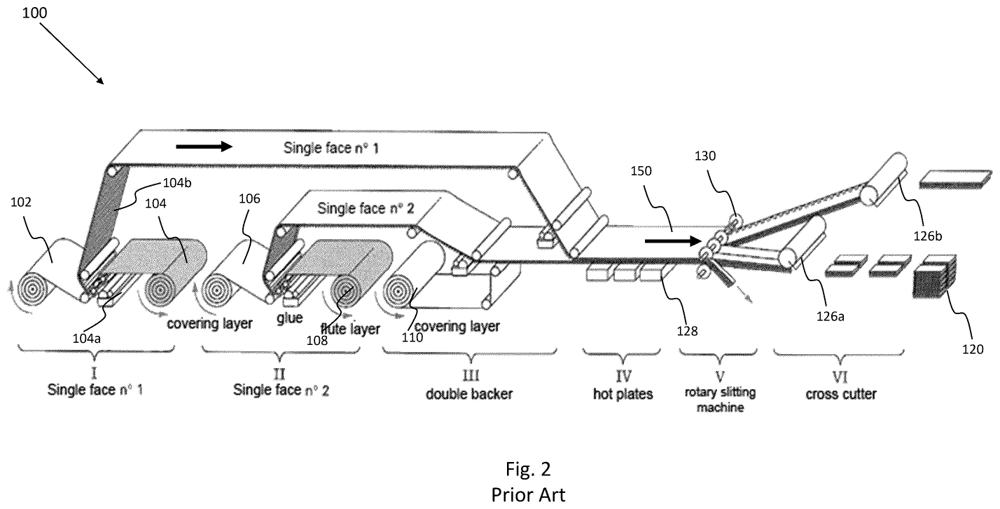

A general process and machine structure 100 for producing a 5-layer corrugated board are described in FIG. 2. This 5-layer description is provided as an example. The general process and machine structure for producing 2-layer, 3-layer or 7-layer corrugated boards are similar, and as noted, the invention applies to a corrugator for producing corrugated cardboard that includes any number of layers.

Machine 100 includes five feeding reels of paper, containing, respectively, a first external layer 102, a second external (covering) layer 110, a first flute (corrugation) layer 104, a second flute layer 108, and a middle covering layer 106. In the first stage, the first external layer 102 is attached by glue to the first flute layer 104. Flute layer 104 passes a corrugation mechanism 104a before attachment by glue to the bottom of the first external layer 102. Next, and similarly, second flute layer 108 is attached (by glue) to the middle covering layer 106, and then external layer 110 is attached to the other (bottom) side of the second flute layer 108. Next, the unified corrugated 3-layer structure that includes layers 106, 108, and 110 is attached to the bottom 104b of flute layer 104, producing a 5-layer strip 150. Next, the 5-layer strip 150 passes heating plates 128, configured to dry the glue on the strip. In some cases, particularly in high throughput corrugators, the glue-drying is performed by a unit distinct from the main section of the corrugator, this unit is sometimes positioned above the main unit (in such a case, the strip is returned to the main section for cutting, as will be detailed below). Following the drying stage, the strip passes two stages that respectively include two sets of cutting blades: (a) longitudinal cutting blades 130; and (b) transverse cutting blades 126 (two separate transverse cutting blades 126a and 126b are shown as an example). The longitudinal and transverse blades 126 and 130 are included, as a standard, in all prior art corrugators 100, resulting in the output production of separate boards 120. The operator of corrugator 100 can configure the dimensions of the output boards 120 by adjusting the location and number of blades used; however, the separate output boards are traditionally the standard product of corrugator 100, no matter how many layers are included.

As noted, the distinct (separate) boards are then transferred to a die-cutting machine, designed, as a standard, to receive separate corrugated boards at its input and to output separate shaped boards ready to form 3-dimensional boxes (for example).

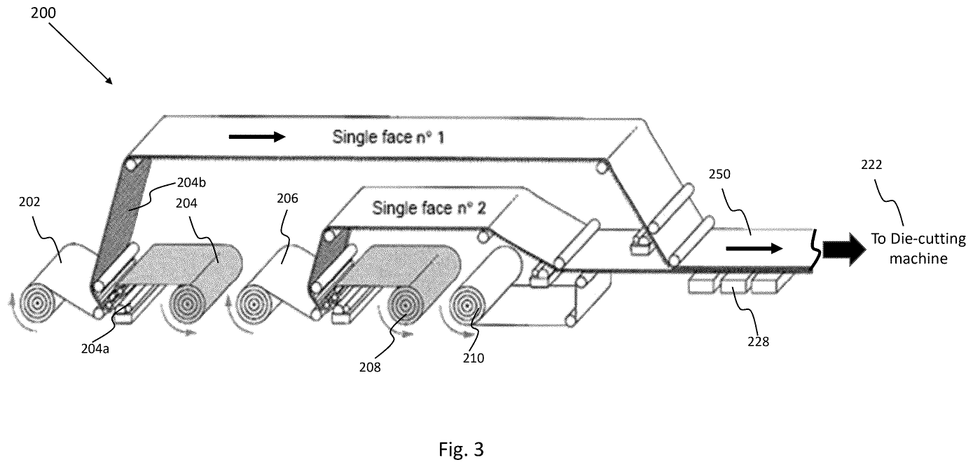

FIG. 3 illustrates the general structure of a modified corrugator 200, according to an embodiment of the invention. Modified corrugator 200 is substantially the same as the corrugator 100 of FIG. 2, excluding the longitudinal blades 126 and transverse blades 130, which are eliminated and do not exist in modified corrugator 200. As a result, the “elongated” strip 250 is the output product of modified corrugator 200, and this strip is conveyed 222 directly to the die-cutting machine (not shown in FIG. 3). This structure contrasts with corrugator 100, where separate boards 120 are conveyed (or shipped) to the following die-cutting machine.

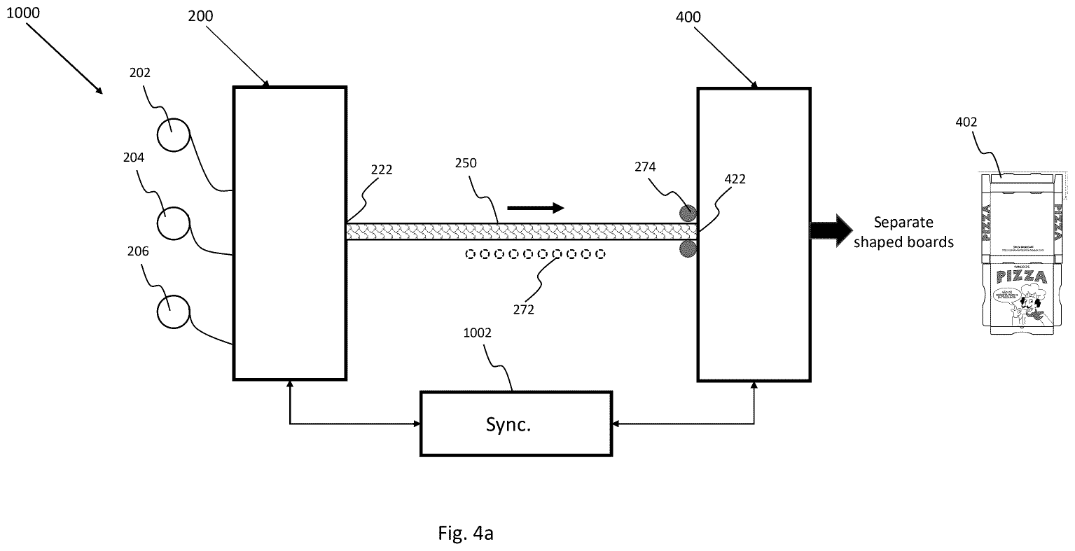

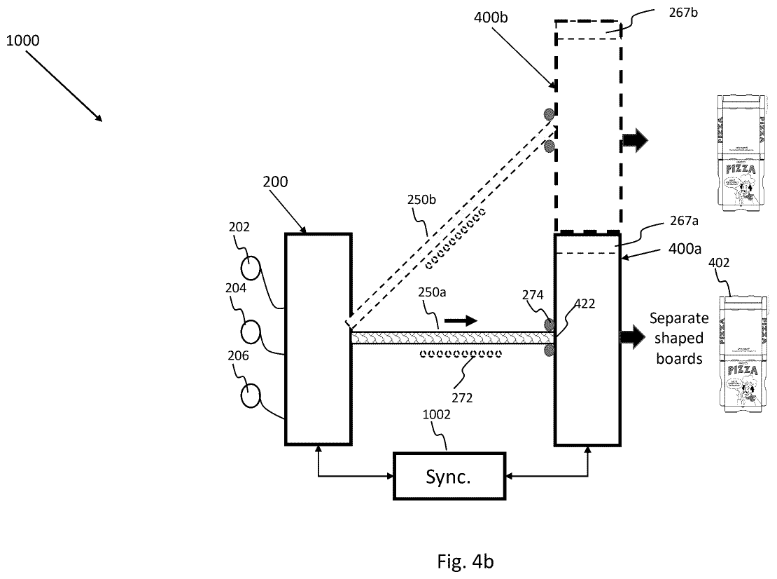

FIG. 4a schematically illustrates the general structure of a system 1000, according to an embodiment of the invention. First, as in FIG. 3, modified corrugator 200 (which in this specific case fabricates a 3-layer product for creating a 3-D pizza box) is fed with a plurality of paper liners 202, 204, and 206. The modified corrugator processes the input liners like the process described in FIG. 3 and outputs a multi-layer corrugated elongated strip 250 (in this specific case, a 3-layer elongated strip). Then, the 3-layer corrugated strip 250 is conveyed to a die-cutting machine 400 that repeatedly cuts the strip to a plurality of shaped boards 402, for example, boards ready to prepare 3-D pizza boxes. The process is performed continuously and repeatedly so that die-cutting machine 400 pulls and cuts strip 250 into pieces, and it also shapes the pieces such that distinct shaped cardboards 402 are outputted. Cutting the strip into pieces and shaping them may be performed simultaneously with the same template. Various types of templates known and common in the art may be used by the die-cutting machine 400, such as a flatbed template, a rotated template, etc. The input strip 250 may include a preprint on the top or bottom side of the strip, such that shaped boards 402 are ready to use by the end-user. The print may be performed within modified corrugator 200 or included in preprinted external paper liners 202 or 210. Alternatively, the print may be applied after the die-cutting stage, as is most conventional in prior art corrugator-die cutting systems.

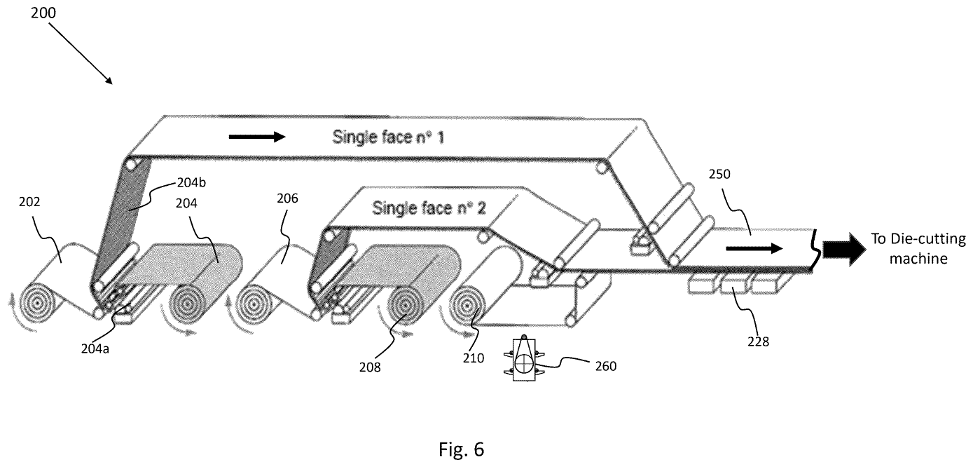

A typical prior art corrugator does not include a built-in printing device. In one embodiment, the modified corrugator 200 of the invention may include a built-in printing device 260, as shown in FIG. 6, that prints on external layer 210. The built-in printing device 260 may be a flexo-type printer, an offset printer, a rotative printer, digital printer. When operating with a printed strip, the die-cutting machine 400 includes a sensor (for example, an optical sensor, not shown) that synchronizes the timing of the cutting operations based on, for example, the print on the strip.

As noted, conventional die-cutting machines for processing corrugated cardboards are designed to receive separate corrugated boards, not an elongated strip. Therefore, various adaptations should be made to an existing (already marketed product) die-cutting machine to receive a strip of corrugated cardboard. Alternatively, a new and compatible die-cutting machine may be produced to receive strip 250. These adaptations are relatively simple, as most of the regular functions of the die-cutting machine remain the same. For example, to obtain a smooth and reliable operation, the inventor has found that adding an optional assisting feeder 274 (having, for example, rollers) is preferable. As previously noted, within the modified corrugator 200, the transverse and longitude blades are eliminated or disabled.

Die-cutting machine 400 may include either a rotative-type cutter or a flatbed-type cutter. These two types of die cutters are well known and widely used within die-cutting machines.

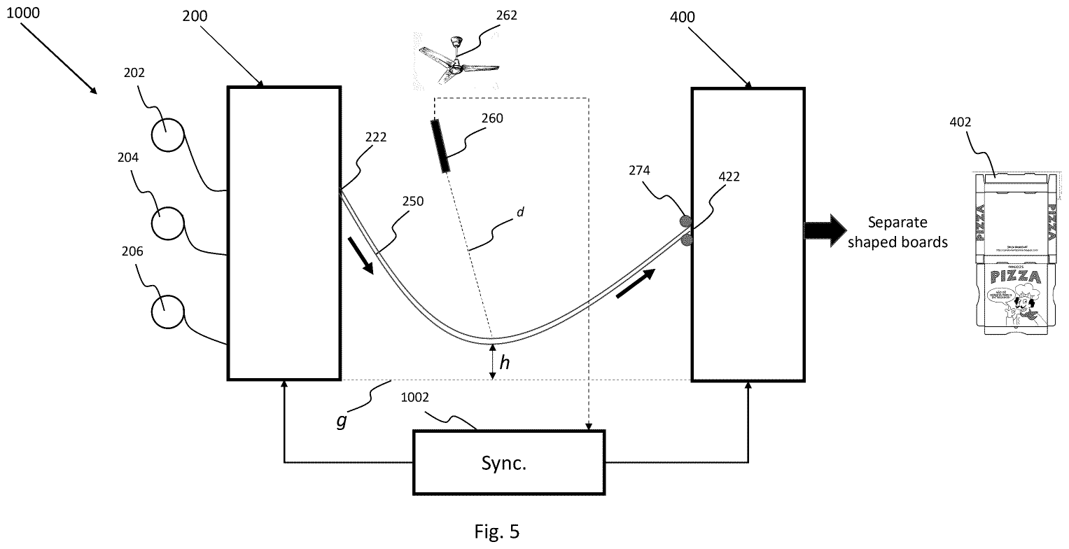

The fact that the corrugator and the die-cutting machines are designed to operate independently in the prior art systems (in many cases even remotely from one another), enables each unit (corrugator or die-cutting machine) to operate at its own speed and throughput without significant effects or necessity for synchronization between them. However, in the present invention's system 1000, the two units 200 and 400 must b synchronized to avoid glitches, or the two machines must be tuned to operate precisely at the same speed. Such a synchronization unit 1002 is schematically shown in system 1000 of FIG. 4a. Conventional corrugator and die-cutting machines typically have speed adjustments to some degree, and these adjustments can be used. The inventors have found that, preferably, particularly when the die-cutting machine 400 utilizes a flatbed-type template, additional speed compensations have to be provided beyond the regular speed adjustments (in the two machines 200 and 400) for a reliable long-term operation. In contrast to the rotatable type template, where the die-cutting is performed continuously, the flatbed-type die-cutting machine moves its cutting element up and down between two consecutive operations creating “pauses”; More specifically, the flatbed-type die-cutting machine operates in “beats,” a manner of operation inconsistent with the continuous movement of a strip coming from the corrugator, as is needed in the present system. FIG. 5 provides a synchronization structure that can compensate for such pauses or may be used in some other embodiments of the invention.

FIG. 5 illustrates one type of synchronization of system 1000, particularly suitable for a flatbed-type die cutter, according to an embodiment of the invention. Strip 250 is hung in a buffer zone between outlet 222 of modified corrugator 200 and inlet 422 of die-cutting machine 400. As shown, strip 250 is designed to form a curve by hanging a height h above the ground g (h defines the minimal height substantially in the middle distance between the two units 200 and 400). The height h is supposed to be kept constant in a regular operation. Laser unit 260 is fixed above strip 250 and measures the distance d (which linearly corresponds to height h), conveying this measurement d to the synchronization unit 1002. When the speed of modified corrugator 200 increases relative to the speed of die-cutting unit 400, height h decreases (meaning that distance d increases), and the synchronization unit 1002 instructs the corrugator to reduce its operating speed. Alternatively, it may instruct the die-cutting machine to increase its speed of operation. In another situation, when the speed of modified corrugator 200 is reduced relative to the speed of die-cutting unit 400, height h increases (meaning that distance d decreases), and the synchronization unit 1002 instructs the corrugator 200 to increase its speed of operation. Alternatively, it may instruct the die-cutting machine to decrease its own speed of operation. In such a manner, synchronization unit 1002, utilizing laser 260 and a reference height h, monitors and matches the speeds of operation of units 200 and 400, and compensates for any deviation (including the “pauses” that are typical to flatbed-type die-cutters). A variety of other synchronization structures may be used. Such synchronization structures may utilize a light sensor, an electromagnetic sensor, pressure sensors, etc. In other embodiments, the synchronization may be performed directly between the two units without using an external synchronizer 1002. For example, when using a rotatable cassette within die cutter 400, the external synchronization unit 1002 may be avoided. In such a case, speed signals may be shared between the two units 200 and 400, and utilized within the units to tune the speeds, respectively.

Moreover, when using a rotatable cassette within the die-cutter 400, strip 250 may go directly and without a curve between the two units, as shown in FIG. 4a. The external synchronization 1002 may also be avoided in such a configuration. A static or dynamic conveyor 272 may also be used between the two units to assist the strip movement. The elimination of the necessity for the curve shown in FIG. 5 saves space, as the two machines, 200 and 400, can be positioned closer.

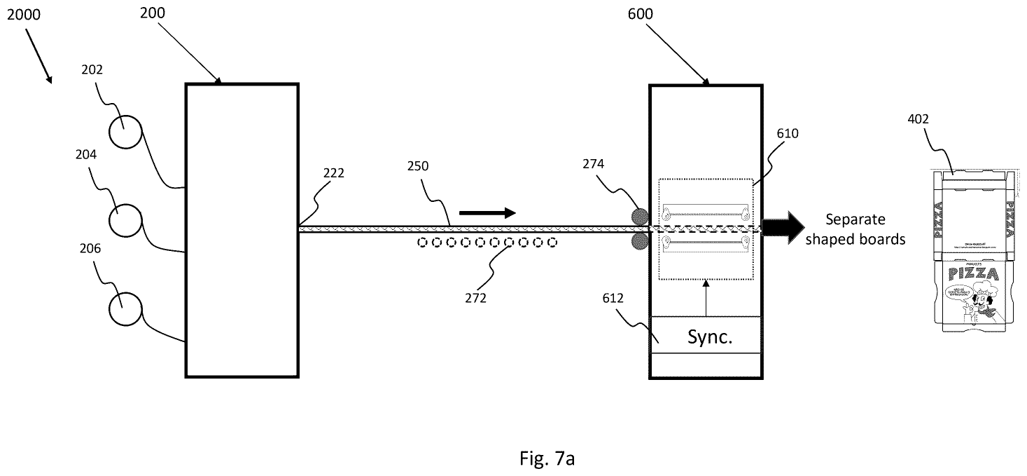

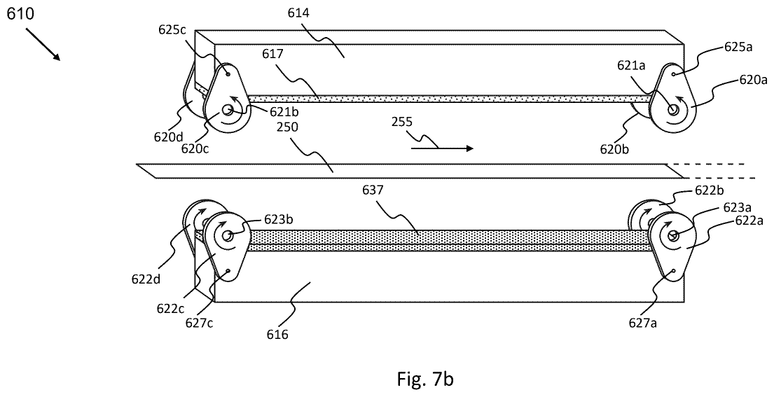

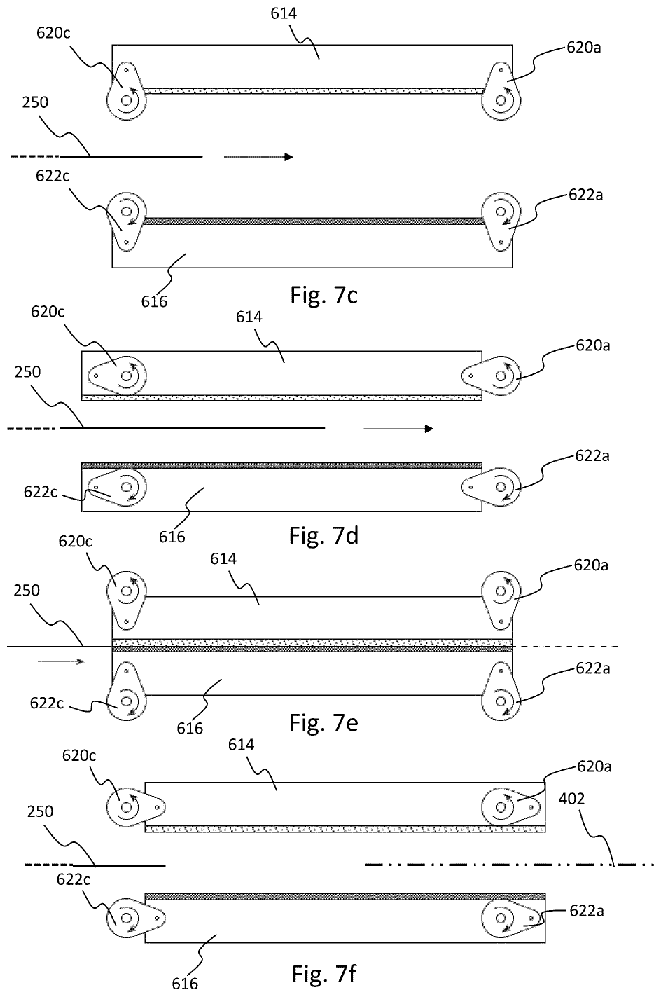

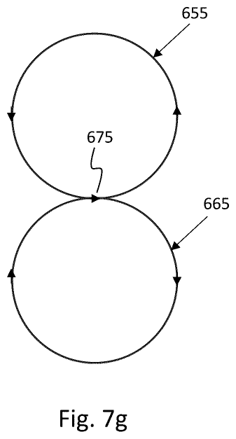

FIG. 7a illustrates in a schematic block diagram form a system 2000, which includes a flatbed-revolving die-cutting machine, according to an additional embodiment of the invention. Numeral indications in FIG. 7 similar to those of FIG. 4a refer to similar functionalities. Die cutting machine 600 includes a flatbed-revolving unit 610 that combines characteristics of flatbed and rotational die-cutters. In contrast to a conventional flatbed-type die-cutting machine that operates in “beats,” the flatbed-revolving die-cutting machine 600 operates continuously, although it includes a flatbed template. The synchronization unit 612 synchronizes the speed of movement of flatbed-revolving unit 610 to match it to the speed of movement of corrugated (and elongated) strip 250.

FIG. 7b illustrates the basic structure of flatbed-revolving unit 610 (shown in FIG. 7a), according to an embodiment of the invention. The unit includes two supporting bases, an upper supporting base 614 and a lower supporting base 616, that continuously and mutually move in a manner that is elaborated below. Upper base 614 typically supports a replaceable template 615, while the lower 616 base typically supports a flat plate 637. Flat plate 637 is optional, as the top flat surface 637 of the lower base 616 may be used instead (or flat plate 637 may be an integral part of lower base 616). Similar to the flatbed-type die cutter used in FIG. 5, the elongated strip moves between the upper base 614 and the lower base 616, such that when the two bases engage one another, strip 250 is cut to one or more shaped boards. Each of bases 614 and 616 is maintained horizontally while continuously moving in a revolving manner.

Each of bases 614 and 616 is rotationally connected, substantially at its four corners (625a, 625b, 625c, 625d for the upper base, and 627a, 627b, 627c, 62dd for the lower base) to four driving elements, 620a-620d and 622a-622d, respectively. As shown, each pair of driving elements located at the same base edge (620a, 620b or 620c, 620d of the upper base, and 622a, 622b, or 622c, 622d of the lower base) is driven by the same axle (axles 621a and 621b for the upper base, and axles 623a and 623b for the lower base). All four axles are synchronously driven from the same driving source (e.g., an electrical motor, not shown); however, the two axles 621a, 621b of the upper base 614 are driven in opposite directions relative to the two axles 623a, 623b of the lower base 616. The upper and lower axles' rotation directions are set such that template's 617 engagement with strip 250 and lower plate 637 involves a temporary movement vector in the advance direction 255 of strip 250. Later on, and following the continuous rotation of axles 621a, 621b, and 623a and 623b, the two bases separate while strip 250 progresses until re-engagement and production of new one or more shaped boards 402 (FIG. 5). Of course, each such engagement results in one or more new shaped boards 402; The number of boards produced depend on the template's design.

FIGS. 7c-7f illustrate four states of the flatbed-revolving unit 610. In a first state shown in FIG. 7c, the two bases are at the most separated position due to the angular states of driving elements 620a, 620c, 622a, a and 622c. Following a previous production of shaped board 402, strip 250 enters the space between the two bases. In a second state shown in FIG. 7d, the two bases are closer due to the angular states of driving elements 620a, 620c, 622a, and 622c. Strip 250 has somewhat advanced in the space between the two bases (compared to its position in FIG. 7c). In the third state shown in FIG. 7e, the two bases 614 and 616 engage strip 250, producing one or more shaped products 402. In a fourth state shown in FIG. 7f, the two bases 614 and 616 separate again due to the angular states of driving elements 620a, 620c, 622a, and 622c. The ready shaped product 402 is on its way out of the flatbed-revolving unit 610, while a new section of strip 250 just enters the space between the two bases. The process of FIGS. 7c-7f continues “endlessly”, repeatedly producing shaped products 402.

It should be noted that the rotation speed of the synchronous axles 621 and 623 is carefully tuned based on the desired size of the shaped product 402 and the rate of progress of strip 250. This process practically produces opposite revolvings of the two bases 614 and 616, as shown in FIG. 7g. The upper circle 655 illustrates the counter-clockwise movement of each point on the surface of template 617 (FIG. 7b). The lower circle 665 illustrates the clockwise movement of each point on the surface of plate 637 (FIG. 7b). Arrow 675 indicates the temporary motion which occurs at the template 617, at the time of engagement with strip 250. This movement vector is carefully tuned to match the speed of strip 250. An indication regarding the speed of the strip can be obtained, for example, from sensors positioned adjacent to the strip. It should also be noted that other mechanical arrangements may be applied for the two plates' structure to obtain either circular movements (as shown in FIG. 7g) or ellipse. The number of driving elements 620, 622 may also vary.

FIG. 4b shows still another embodiment of the system of the invention, comprising two alternatively working die-cutting machines 400a and 400b). As is common, a typical die-cutting machine includes a template 267a, 267b, either flatbed-type or rotary-type, defining the shape of the final product. Following any template replacement, the die-cutting machine must be fine-tuned (offline, when the die-cutting machine is inactive) to adapt to the newly installed template. Each such adjustment consumes a significant working time, tens of minutes, where the entire system must shut down. To eliminate this shut-down time, the system of FIG. 4b includes two alternatively operated die-cutting machines, 400a and 400b. Before replacing a new system job (namely, to produce another output product), the new template 267b is inserted into the currently-inactive die-cutting machine (in this case, die-cutting machine 400b). Die-cutting machine 400b is fine-tuned while offline and while the system 1000 still continuously operates with die-cutting machine 400a. Only when the adjustment of die-cutting machine 400b has finalized, the system's operation is terminated, strip 250b is inserted into the inlet of the die-cutting machine 400b, and the operation is again initiated to produce the new product. In a similar manner, the same procedure may be performed to produce still another product, while switching back to die-cutting machine 400a. Preferably, die-cutting machine 400b is mounted on top of die-cutting machine 400a, however, this is not a must. The structure of the system of FIG. 4b (with the two die-cutting machines) also applies to the designs of FIGS. 3, 5, and 6, mutatis mutandis.

### Example 1

As noted, the conventional corrugator and die-cutting machines are not designed to interact with corrugated strips. On the one hand, the conventional corrugator is designed to output separate boards, not an elongated strip. On the other hand, the conventional corrugator-type die-cutting machine, in turn, is designed to receive separate boards. As noted, the traditional transverse and longitudinal blades (126a, 126b, and 130, respectively, in FIG. 2) are eliminated within the modified corrugator 200 of the invention.

The inventors have built the system 1000 with a curved strip 250 at a buffer zone, as shown in FIG. 5. A 3-layer corrugator, model PY 1300 manufactured by Han Da Machinery Co., Ltd., was used. The longitudinal and transverse blades were eliminated from the corrugator.

The inventors have found that a die-cutting machine 400 that can receive a corrugated strip 250 does not exist in the market; therefore, another alternative had to be found. For this purpose, the inventors used a flatbed-type die-cutting machine originally designed to produce disposable cutlery, Power: 14 KW, Model #: PY 1300, speed: 30-200 m/min manufactured by Dakiou, CN. A synchronization unit 1002, such as the one in FIG. 5 was used, as well as feeding assisting element 274. A blower 262 was also positioned above the strip to maintain it relatively stable during the intensive operation of the system, as well as a laser 260. The preprinted strip moved at a speed up to 50 m/min, producing 350 pizza boxes per minute. An optical synchronization sensor was used within the die-cutting machine to correctly cut the preprinted strip. The distance between the two units was 12 m; however, any distance between 3-18 meters may be used when using a flatbed-type die-cutting machine. When using a rotatable die-cutting machine, the distance between the two units can be reduced even to less than 1 m. Distances above or below these ranges may be operable but less preferable. For this experiment, the inventors used a corrugator in which one of the layers was preprinted. Moreover, a glue drying machine manufactured by HANDA, was positioned above the main unit of the corrugator to save space. It is estimated that the invention's system consumes a space at least 60% smaller than the space consumed by a comparable system of the prior art. The system of the invention may use standard 1600 mm strip, 2800 mm strip, or any other strip's width commonly used. For the example, a 1600 mm strip was used.

The inventor believes that a replacement of the product's collecting unit, at the outlet of the die cutting machine could reliably increase the speed of the tested system to 80 m/min).

### Example 2

A second experiment was performed with a system including a corrugator with two alternatively operating (a) flatbed-type die cutting machine and (b) rotary-type die cutting machine. The rotary-type die cutting machine, together with a glue drying machine were positioned on top of the flatbed-die-cutting machine. In this case, when the flatbed die-cutting machine was active, a speed of 50 meters per minute was obtained. When the rotary-type die-cutting machine was active, a speed of 100 meters per minute was obtained.

The weight of the rotative-type die-cutting machine is typically significantly less compared to the weight of the flatbed-type die-cutting machine. However, while a flatbed-type template costs about 300 USD, a rotatable-type template costs about 3000 USD.

Several simple adaptations were made to the die-cutting flatbed and rotatable machines. Both machines typically include board feeding units that are no longer necessary in the system of the invention using an elongated strip. Therefore, these feeding units were eliminated.

It was also found that the invention's system is advantageous in saving material. While a waste of about 3-5% of material is typical in the prior art corrugating line alone, and additional material waste of 7-10% is typical in an offline die-cutting system, the total waste in the entire (corrugator and die-cutter) system of the present invention was reduced to about 3-5%.

The invention's system can typically be operated by 2-3 operators. This is compared to about ten workers necessary to operate a comparable prior art system, particularly if the prior art system is divided between two geographic locations. The invention system also saves manufacturing space. In the prior art corrugator-die cutter system, the finished boards from the corrugator must go to a warehouse on pallets, then to individual processors for a print and cut, and only then to the final consumer. Alternatively, they are placed in a huge temporary storage warehouse for boards, waiting to be taken into production on an internal die-cutting machine. In contrast, no temporary storage warehouses are needed in the present invention—the finished products are immediately produced and can immediately be transferred to the final consumer.

While some embodiments of the invention have been described by way of illustration, it will be apparent that the invention can be carried into practice with many modifications, variations, and adaptations, and with the use of numerous equivalent or alternative solutions that are within the scope of persons skilled in the art, without departing from the spirit of the invention or exceeding the scope of the claims.

1. A unified corrugator and die-cutting system, comprising:
a corrugator configured to produce an elongated and multi-layer moving strip of corrugated cardboard; and
a die-cutting machine configured to receive said strip of corrugated cardboard and repeatedly cut it to a plurality of shaped boards.

2. The system of claim 1, wherein transverse and longitudinal blades are eliminated at the corrugator.

3. The system of claim 1, wherein the elongated multi-layer strip includes 2, 3, 5, or 7 layers.

4. The system of claim 1, wherein the strip includes a print, and wherein the print is selected from preprinted, printed within the corrugator, or printed within or after the die-cutting machine.

5. The system of claim 4, wherein the corrugator includes a built-in printer selected from a flexo-type printer, an offset printer, a rotative printer, or a digital printer.

6. The system of claim 1, wherein a separate glue-drying unit of the corrugator is positioned above the corrugator's main body.

7. The system of claim 1, further comprising synchronization between the strip's speed of movement at the corrugator's outlet and the die-cutting machine's speed of operation.

8. The system of claim 7, wherein the synchronization is performed utilizing a synchronization unit external to the corrugator and the die-cutting machine at an area between them.

9. The system of claim 8, wherein said synchronization unit comprising:
said strip forming an above-ground curve of a predefined height h;
a laser unit continuously measuring said height h and feeding said height to a synchronization entity; and
said synchronization entity configured to receive said height h and adjust one or more of the corrugator or die-cutting machines' speed of operation to keep the height h constant.

10. The system of claim 7, wherein said synchronization is obtained by a die-cutting machine, which comprises:
higher and lower bases, wherein the higher base comprises a flatbed template facing down, and the lower base comprises a flat surface facing up towards said template;
mechanism configured to apply a revolving circular or ellipsoidal movement to each said upper and lower bases, such that upon engagement, said two bases are horizontal relative to a corrugated strip passing between them; and
a synchronization unit configure to synchronize between a horizontal movement vector of the two bases and between a speed of the strip moving between them at each engagement time.

11. The system of claim 10, wherein said mechanism comprising:
driving elements at each said upper and lower bases;
axels attached to said driving elements; and
a motor configured to apply opposite-direction rotation to the axels driving the upper base relative to the axels driving the lower base.

12. The system of claim 1, further comprising a feeding assistance device at the entry of the die-cutting machine.

13. The system of claim 1, wherein the die-cutting machine is selected from rotatable or flatbed type die-cutting machines.

14. The system of claim 1, further comprising a static or dynamic conveyor between the corrugator and die-cutting machine, which is configured to assist in the movement of the strip.

15. The system of claim 1, comprising two alternatively-operated die-cutting machines.

16. A method for producing shaped corrugated boards, comprising:
providing a corrugator that is configured to produce an elongated multi-layer corrugated strip; and
providing a die-cutting machine configured to continuously receive said elongated multi-layer corrugated strip and cut the strip to separate shaped boards.

17. The method of claim 16, further comprising printing the strip before the corrugator, within the corrugator, or within the die-cutting machine, or printing the separate shaped boards outside the die-cutting machine.

18. The method of claim 16, further comprising synchronizing between the corrugator's and die-cutting machine's operation speeds.

19. The method of claim 16, further comprising:
providing a second die-cutting machine, while at any given time, at most one of the die-cutting machines is active and the other is inactive;
when an alteration to a new job is desired, mounting a new template within the inactive die-cutting machine, and fine-tuning the inactive die-cutting; and
activating operation with the newly tuned die-cutting machine.
